(19) United States
(12) Patent Application Publication
(10) Pub. No.: US 2022/0281549 A1
(43) Pub. Date: Sep. 8, 2022

(54) COLLAPSIBLE BICYCLE

(71) Applicant: Mark L. Groendal, Grandville, MI (US)

(72) Inventor: Mark L. Groendal, Grandville, MI (US)

(21) Appl. No.: 17/654,066

(22) Filed: Mar. 8, 2022

Related U.S. Application Data
(60) Provisional application No. 63/190,935, filed on May 20, 2021.
(60) Provisional application No. 63/158,212, filed on Mar. 8, 2021.

(51) Int. Cl. B62K 15/00

(52) U.S. Cl. CPC B62K 15/006

(57) ABSTRACT

A bicycle frame including a down tube that is releasably connected to a bottom bracket shell, and a top tube that is selectively rotatable about a portion of the seat tube. The bicycle can selectively be placed into a ridable position when the front portion of the frame aligns with the rear portion of the frame, or selectively rotated into a collapsed position by disconnecting the down tube from the bottom bracket shell and rotating the top tube about the seat tube.

### CROSS REFERENCE TO RELATED APPLICATIONS

This application claims the benefit of U.S. Provisional Application Nos. 63/158,212, which was filed on Mar. 8, 2021, and 63/190,935, which was filed May 20, 2021, the disclosures of which is hereby incorporated by reference.

### BACKGROUND OF THE INVENTION

### 1. Field of the Invention

The present invention relates to bicycles. More particularly, the present invention pertains to a bicycle that can be collapsed or folded for ease of transportation.

### 2. Description of the Prior Art

Bicycles are one of the oldest and most economical means of transportation. Although traditional bicycles are rather light weight, they cannot be easily stored or transported due to their bulkiness and size. When they are carried, shipped, or transported for a long distance, freight charges often represent a very high percentage of the relocation costs. The present invention overcomes some of these disadvantages. The invention contemplates a collapsible/folding bicycle that minimizes storage space, and enables transportation and handling to be easier and simpler.

### SUMMARY OF THE INVENTION

According to an aspect of the disclosure a bicycle frame is disclosed which comprises a front frame having a top tube, a down tube, and a head tube, the top tube being attached to the head tube, and the down tube being positioned below the top tube and further being attached to the head tube;

a rear frame having a pair of spaced-apart seat stays, a pair of spaced-apart chain stays, and a bottom bracket shell, each of the seat stays and the chain stays having a rear end and a front end, the rear ends of the seat stays and the rear ends of the chain stays being connected to a rear drop out, the front end of each chain stay being connected to the bottom bracket shell, and the down tube being releasably connected to the bottom bracket shell;

a seat tube arranged between the front frame and the rear frame and coupled to the front frame and the rear frame, the seat tube having an upper tube and a lower tube, the upper tube and the lower tube being selectively rotatable with respect to one another, the upper tube being connected to the top tube, the lower tube being connected to the front end of the seat stays, and the bottom bracket shell being connected to the lower tube;

wherein the bicycle frame is adapted to be configured in a first position or a second position, in the first position the front frame is positioned forwardly of the seat tube, and in the second position the front frame is rotated rearwardly of the seat tube, wherein the bicycle frame is moved from the first position to the second position by disconnecting the down tube from the bottom bracket shell and rotating the upper tube of the seat tube with respect to the lower tube of the seat tube.

The bicycle frame can optionally include a locking clip for selectively securing the upper tube of the seat tube to the lower tube of the seat tube to thereby restrict rotation therebetween, the locking clip includes a crank lock that is adapted to move between a lock position and an unlock position.

The bicycle frame can further optionally include wherein the down tube includes a frame engagement section including a transverse hole, and the bottom bracket shell includes a stem having a pair of spaced-apart flanges, each of the flanges have a though hole which is aligned with one another and oriented axially with the transverse hold of the frame engagement section, wherein the down tube and the bottom bracket shell are connected to one another by inserting the frame engagement section between the flanges so that the transverse hole aligns with both of the through holes, and then inserting a locking pin through the through holes and the transverse hole.

Optionally, the locking pin is a clevis pin.

The bicycle frame can alternatively and optionally include a locking coupler for selectively securing the upper tube of the seat tube to the lower tube of the seat tube to thereby restrict rotation therebetween, the locking coupler having a male coupler and a female coupler, the male coupler including a plurality of tongue members, and the female coupler including a plurality of grooves, the tongue members and the grooves being dimensioned so that the tongue members are arranged inside the grooves to prevent rotation between the upper tube and the lower tube.

According to another embodiment, there is disclosed a bicycle frame comprising a front frame having a top tube, a down tube, and a head tube, the top tube being attached to the head tube, and the down tube being positioned below the top tube and further being attached to the head tube;

a rear frame having a pair of spaced-apart seat stays, a pair of spaced-apart chain stays, a seat tube, and a bottom bracket shell, each of the seat stays and the chain stays having a rear end and a front end, the rear ends of the seat stays and the rear ends of the chain stays being connected to a rear drop out, the front end of each chain stay being connected to the bottom bracket shell, the front end of each seat stay being connected to the seat tube;

the down tube being releasably connected to the bottom bracket shell, and the top tube being rotatably connected to the seat tube;

wherein the bicycle frame is adapted to be configured in a first position or a second position, in the first position the front frame is positioned forwardly of the seat tube, and in the second position the front frame is rotated rearwardly of the seat tube, wherein the bicycle frame is moved from the first position to the second position by disconnecting the down tube from the bottom bracket shell and rotating the top tube about the seat tube.

The bicycle frame can optionally include a rotation bracket having a first half portion and a second half portion, the first half portion being fixedly engaged with a rear end of the top tube, and the second half portion partially surrounding the seat tube and engaged with the first half portion and the seat tube, the first half portion and the second half portion define an elongated channel through which the seat tube extends, the first half portion and the second half portion are fixedly attached together at a first lateral end, and the first half portion and the second half portion are secured together at a second lateral end.

Optionally, the first half portion and the second half portion are secured together using a locking fastener having a crank lever that is adapted to move between a lock position and an unlock position in which the crank lever tightens the locking fastener such that the first half portion and the second half portion are tightly engaged with each other around the seat tube to prevent the top tube from sliding or rotating relative to the seat tube.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 illustrates a bicycle having a collapsible frame in accordance with an embodiment of the disclosure;

FIG. 2 illustrates an enlarged view of the frame depicting a connector removably connecting a down tube to a head tube, in accordance with an embodiment of the disclosure;

FIG. 3 illustrates an enlarged view of the connector connected with a stem of the head tube, in accordance with an embodiment of the disclosure;

FIG. 4 illustrates an enlarged view of the connector connected with a stem of the head tube and depicting a locking pin arranged partially outwardly of the stem and the connector, in accordance with an embodiment of the disclosure;

FIG. 5 illustrates a top perspective view of the connector, in accordance with an embodiment of the disclosure;

FIG. 6 illustrates an enlarged view of a seat tube of the frame having an upper tube rotatably coupled with a lower tube, in accordance with an embodiment of the disclosure;

FIG. 7 illustrates an enlarged view of the seat tube having a locking coupler engaging the upper tube with the lower tube and restricting a rotation of the upper tube relative to the lower tube, in accordance with an embodiment of the disclosure;

FIG. 8 illustrates an enlarged view of the seat tube having the locking coupler with a male coupling disengaged from a female coupling to allow rotation of the upper tube relative to the lower tube, in accordance with an embodiment of the disclosure;

FIG. 9 illustrates a side perspective view of a frame, in accordance with an embodiment of the disclosure;

FIG. 10 illustrates an enlarged view of FIG. 9 showing the frame having a top tube rotatably coupled to a seat tube, in accordance with an embodiment of the disclosure;

FIG. 11 illustrates an enlarged view depicting a cutout of a bracket and an alignment structure arranged in the cut-out, in accordance with an embodiment of the disclosure;

FIG. 12 illustrates an enlarged view of the seat tube having a locking coupler engaging the seat tube and restricting a rotation of an upper portion of the seat tube relative to a lower portion of the seat tube, in accordance with an embodiment of the disclosure; and

FIG. 13 illustrates an alternative embodiment of the frame in which the top tube rotatably connects to the seat tube below the location on the seat tube which is connected to the seat stays.

### DETAILED DESCRIPTION

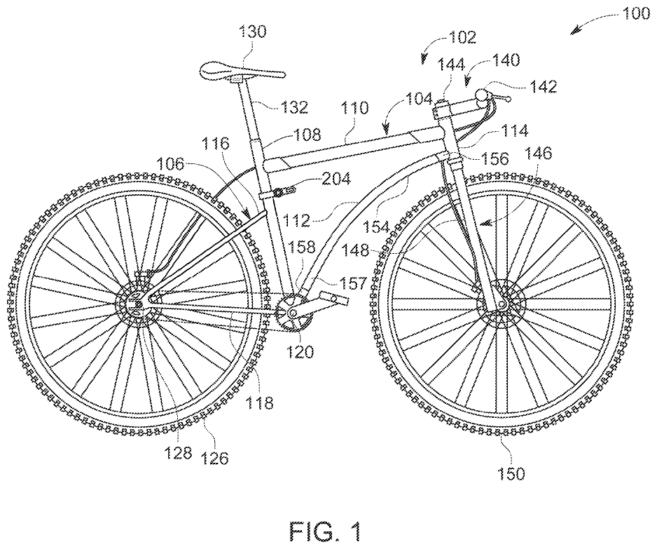

Referring to FIG. 1, there is shown a bicycle 100 having a flexible frame 102 which is foldable and collapsible to allow the bicycle 100 to be easily carried, shipped, or transported. The bicycle 100 may be a mountain bike, a road bike, a BMX bike, a trail bike, a time trial bike, a city bike, a casual use bike, an electric bike, or any other style of bike known in the art. As shown, the frame 102 includes a first frame 104 (i.e., a front frame 104), a second frame 106 (i.e., rear frame 106), and a seat tube 108 arranged between the front frame 104 and the rear frame 104 and connected to the front frame 104 and the rear frame 106. As described in greater detail below, the seat tube 108 functions as a pivot point to fold the front frame 104 and the rear frame 106 toward each other, thereby significantly reducing the overall dimensions of the bicycle when not in use.

The front frame 104 is adapted to be displaced between a first position and a second position relative to the rear frame 106. In the first position, the front frame 104 is arranged forwardly of the seat tube 108 and allows the bicycle 100 to be ridden by a user. And while in the second position, the front frame 104 is arranged rearwardly of the seat tube 108 such that the front frame 104 and the rear frame 106 are folded toward one another to allow easy storage and transportation of the bicycle 100.

The front frame 104 includes a top tube 110, a down tube 112, and a head tube 114, while the rear frame 106 include seat stays 116 and chain stays 118. The rear frame 106, also includes a bottom bracket shell 120 arranged downwardly, or at a lower end, of the seat tube 108 and connected to the seat tube 108. As shown, the rear frame 106 includes two chain stays 118 and two seat stays 116, on opposite sides of a rear wheel 126, with the rear ends of the seat stays 118 and the chain stays 118 being connected to a rear drop out 128 that engages an axle on the rear wheel 126. The frame 102 may be formed from any suitable type of material which is well known in the art, such as aluminum, steel, carbon fiber material, or other conventional materials. A seat 130 is mounted on a seat post 132 that is mounted to the upper end of the seat tube 108, with the seat post 132 fitting downwardly inside a hollow upper seat tube of the seat tube 108.

Furthermore, the bicycle 100 includes a handlebar assembly 140 having a handlebar 142 and a handlebar mount 144 mounted on an upper end of the head tube 114, with the handlebar mount 144 being rotatably mounted on bearings in an open upper end of the head tube 114. A fork assembly 146 is provided which has a pair of spaced-apart forks 148 arranged on each side of a front wheel 150 and connected to the front wheel 150 and a fork steerer tube (not shown) extending upwardly into the interior of head tube 114, where it operably engages with the handlebar mount 144.

In an embodiment, the bicycle 100 is powered by a conventional pedal mechanism attached to the bottom bracket shell 120 at the lower end of the seat tube 108. Alternatively, the bicycle 100 may be powered by an electric motor and an electric battery (not shown) connected to the pedal mechanism. The electric motor and the electric battery may be arranged inside a housing connected to and supported by the seat tube 108. Alternatively, the electric motor may be secured directly to the bottom bracket shell 120, and the electric battery may be secured to (either directly or via a bracket) the down tube 112. Due to the arcuate structure of the down tube 112, at least a portion of the electric battery may be positioned below the axles of the front wheel 150 and the rear wheel 126, thereby lowering the center of gravity of the bicycle 100.

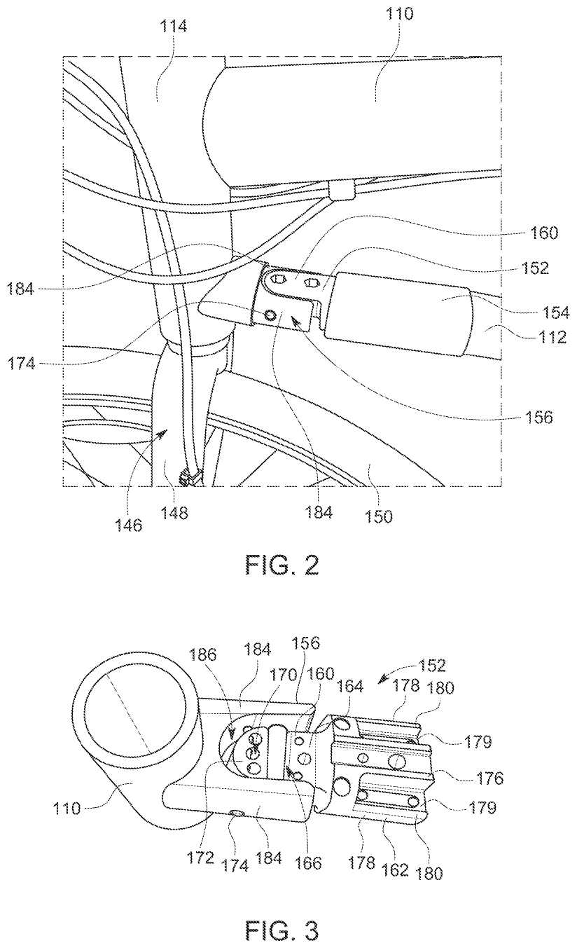

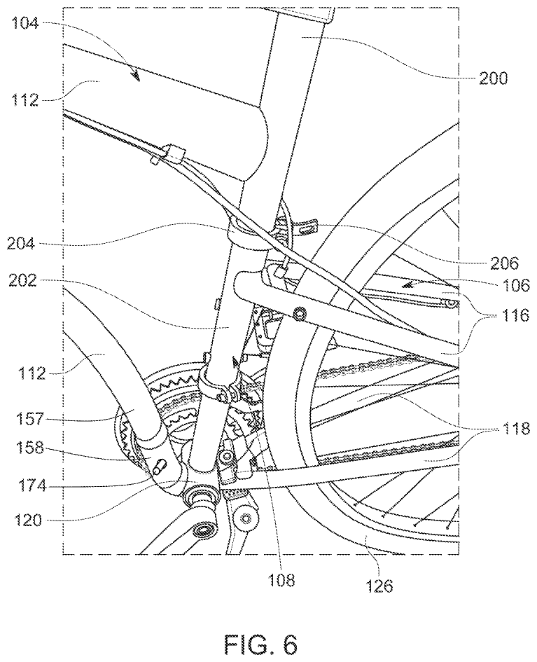

Referring back to FIG. 1, the down tube 112 is an arcuate down tube extending from the head tube 114 to the bottom bracket shell 120. In the embodiment, the down tube 112 includes a removable connector 152 (shown in FIG. 2) connecting a front end 154 of the down tube 112 to a stem 156 extending rearwardly from the head tube 114. And as shown in FIGS. 1 and 6, a rear end 157 of the down tube 112 is connected to a stem 158 mounted to the bottom bracket shell 120, at or near a lower end of the seat tube 108. In the alternative, it is also contemplated that the stem 158 could be welded to the seat tube 108 near the bottom bracket shell 120 or to both at the junction between the bottom bracket shell 120 and the seat tube 108.

Referring to FIGS. 2 to 5, the connector 152 includes a frame engagement section 160 adapted to connect to the stem 156 and a tube engagement section 162 adapted to connect to the down tube 112. A bottom face 164 of the frame engagement section 160 includes a rounded transverse groove or indentation 166, and a transverse hole 170 extending in a lateral direction and arranged proximate to a front end 172 of the connector 152 relative to the transverse groove or indentation 166. Accordingly, the indentation 166 is arranged between the tube engagement section 162 and the transverse hole 170. The transverse hole 170 facilitates an engagement/coupling of the connector 152 with the stem 156 via a locking pin 174.

Further, the tube engagement section 162 has a cross shape, the cross shape having a large vertical rectangular prism portion 176 with “T”-shaped arms 178 extending from both sides of the middle of the prism portion 176. Arms 178 comprise outwardly extending legs 179 and vertical flanges 180. The tube engagement section 162 also includes two screw holes 182 for facilitating a coupling of the tube engagement section 162 with the down tube via fasteners.

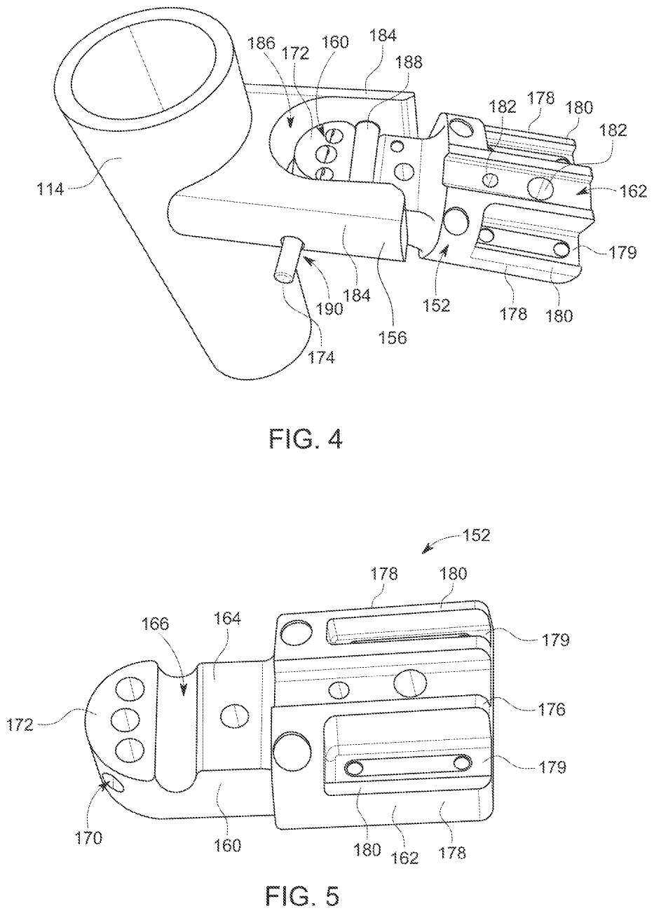

As shown in FIGS. 3 and 4, the stem 156 includes two flanges 184 extending rearwardly from the head tube 114 and arranged spaced apart from each other, defining a gap 186 therebetween to receive, at least partially, the frame engagement section 160. Furthermore, the stem 156 includes a pin 188 connected to the two flanges 184 and extending laterally between the two flanges 184. In an embodiment, the pin 188 may be press fitted to the flanges 184. Moreover, two flanges 184 additionally define two through holes 190 extending in the lateral direction and arranged between the pin 188 and head tube 114. The two through holes 190 are aligned with each other and are adapted to receive the locking pin 174 to facilitate the engagement/coupling of the frame engagement section 160 with the stem 154. Optionally, the locking pin 174 can be a clevis pin which is flared on one end and has a through hole on the opposed end for receiving a cotter pin. The locking pin 174 can alternatively be a clevis pin having a recessed spring-loaded locking ball, such as the type disclosed in U.S. Pat. No. 7,731,465 to Stapulionis et al. and U.S. Pat. No. 2,786,383 to Bachman, and U.S. Patent App. Pub. No. 2011/0162176 to Tylaska et al., the entire disclosures of which are hereby incorporated by reference.

To engage the down tube 112 with the stem 156, the tube engagement section 162 of the connector 152 is inserted inside the down tube 112 and is attached with the down tube 112 by inserting the screws into the screw holes 182 of the tube engagement section 162 of the connector 152 through aligned holes (not shown) of the down tube 112. The tube engagement section 162 is engaged with the down tube 112 such that such that indentation 166 in the frame engagement section 160 is oriented downwardly. Thereafter, the frame engagement section 160 is positioned inside the gap 186 such that the pin 188 is inserted inside the indentation 166 and the transverse hole 170 of the frame engagement section 160 is aligned with the through holes 190 of the two flanges 184. Subsequently, the locking pin 174 is inserted through the through holes 190 and the transverse hole 170 to engage or couple the frame engagement section 160 with the stem 156. In this manner, the down tube 112 is removably connected to the head tube 114.

A connector 152 can optionally be secured to the rear end 157 of the down tube 112, and the seat tube 108 or the bottom bracket shell 120 can optionally include a stem 156 having two flanges 184 extending upwardly and forwardly therefrom. The connector 152, the stem 156 and all of the related structure discussed above to secure the down tube 112 to the head tube 114 can also be used to secure the rear end 157 of the down tube 112 to the seat tube 108 or the bottom bracket shell 120.

Referring to FIG. 6, the seat tube 108 is a tube assembly having a first tube 200 (i.e., an upper tube 200) engaged with the seat post 132 and a second tube 202 (i.e., a lower tube 202) engaged with the bottom bracket shell 120. The upper tube 200 is rotatably coupled with the lower tube 202 and may telescopically extend or retract relative to the lower tube 202. To facilitate an engagement of the upper tube 200 with the lower tube 202, one of the tubes, for example, the lower tube 202 includes a tube section having an outer diameter substantially equal to an inner diameter of the upper tube 200. The tube section is arranged inside the upper tube 200 and the upper tube 200 is adapted to rotate relative to the tube section. Furthermore, the lower tube 202 defines a flange, at a rear end of the tube section, adapted to abut a lower end of the upper tube 200 to restrict a linear movement of the upper tube 200 and the lower tube 202. Moreover, to prevent an undesired rotation of the upper tube 200 relative to the lower tube 202, a locking clip 204 is engaged with the upper tube 200 and the lower tube 202 and is arranged at an interface of the upper tube 200 with the lower tube 202. The locking clip 204 is locked with the upper tube 200 and the lower tube 202 by using a crank lock 206 attached to the locking clip 204. The crank lock 206 is cammed and is adapted to move between a lock position and an unlock position. In the lock position, the crank lock 206 secures the locking clip 204 with the seat tube 108 and prevents a sliding of the locking clip 204 on the seat tube 108, while in the unlock position of the crank lock 206, the locking clip 204 may slide relative to the seat tube 108. To enable the rotation of the upper tube 200 relative to the lower tube 202, the locking clip 204 is moved away from a junction of the upper tube 200 and lower tube 202 by moving the crank lock 206 to the unlock position.

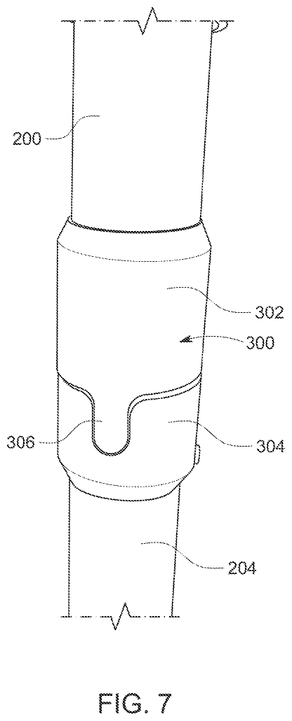

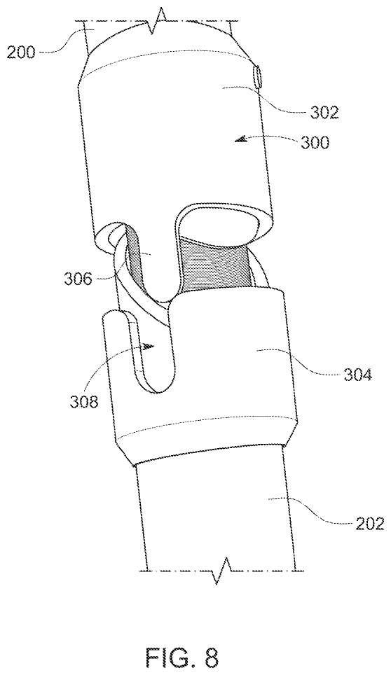

Referring to FIGS. 7 and 8, a locking coupler 300 may optionally be used in lieu of (or in addition to) the locking clip 204. The locking coupler 300 restricts the rotation of the upper tube 200 relative to the lower tube 202. The locking coupler 300 includes a male coupling 302 attached to (or integrally formed with) the upper tube 200, and a female coupling 304 attached to (or integrally formed with) the lower tube 202. The male coupling 302 has a plurality of tongue Tmembers 306 extending in a longitudinal direction and away from the upper tube 200, while the female coupling 304 has a plurality of grooves 308 extending in the longitudinal direction. In an engagement of the male coupling 302 and the female coupling 304, the tongue members 306 are arranged inside the grooves 308 and prevent the rotation of the upper tube 200 relative to the lower tube 202. To rotate the upper tube 200 relative to the lower tube 202, the tongue members 306 are disengaged from the grooves 308. To do so, the male coupling 302 is moved upwardly towards the seat post 132 in a longitudinal direction relative to the upper tube 200, and/or the female coupling 304 is moved downwardly towards the bottom bracket shell 120 relative to the lower tube 202.

Although the tongue members 306 and the grooves 308 are shown in the drawings with dimensions such that the tongue members 306 and the grooves 308 are relatively narrow, the tongue members 306 and the grooves 308 may alternatively be dimensioned such that the width of each tongue member 306 may be approximately equal to the distance on the female coupling 304 between the grooves 308. As such, the tongue members 306 and the grooves 308 may accordingly having a sinusoidal geometry whereby the male coupling 302 and the female coupling 304 have the same or similar shapes which are complementary and mate with one another, such as the areas above and below a sine wave.

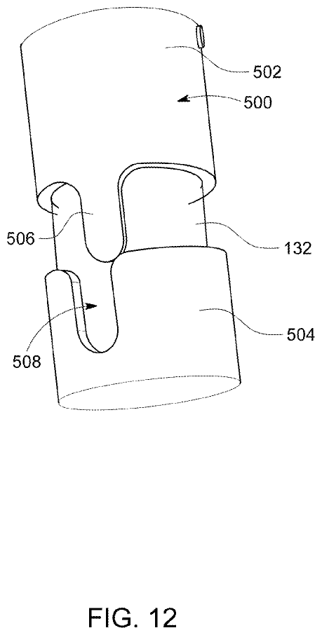

Shown in FIG. 12 is a similar locking coupler 500 to that of the locking coupler 300. The locking coupler 500 functions in the same manner and includes many of the same components, such as a male coupling 502 and a female coupling 504. According to this embodiment, the male coupling 502 and the female coupling 504 are both integrally formed with, and part of, the seat tube 108. The male coupling 502 has a plurality of tongue members 506 extending in a longitudinal direction, while the female coupling 504 has a plurality of grooves 508 extending in the longitudinal direction. In an engagement of the male coupling 502 and the female coupling 504, the tongue members 506 are arranged inside the grooves 508 and prevent therebetween. Importantly, the male coupling 502 and the female coupling 504 concentrically surround and rotate about the seat post 132.

A method of folding of the bicycle 100 is now explained. The method includes disconnecting the down tube 112 from the to the seat tube 108 or the bottom bracket shell 120. A rider disengages the frame engagement section 160 from the stem 156 by removing the locking pin 174 from the transverse hole 170 and through holes 190. Afterwards, or otherwise, the rider may loosen the locking clip 204 by moving the crank lock 206 to the unlock position or may disengage the male coupling 302 from the female coupling 304 to enable a rotation of the upper tube 200 relative to the lower tube 202. Thereafter, the front frame 104 is moved to the second position by rotating the upper tube 200 relative to lower tube 202, thereby folding the bicycle 100.

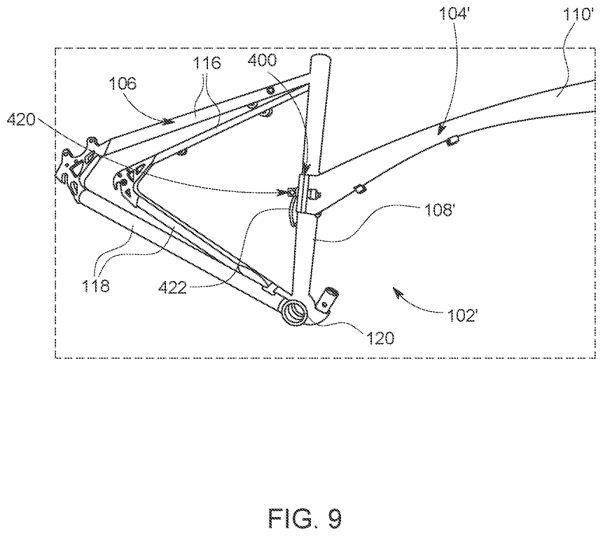

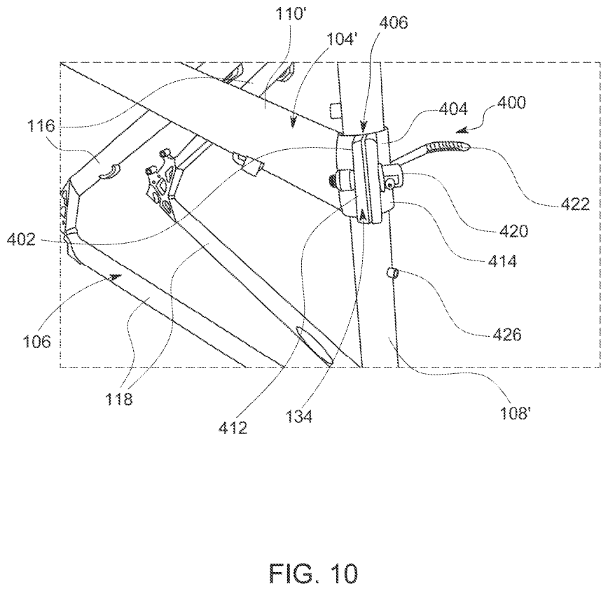

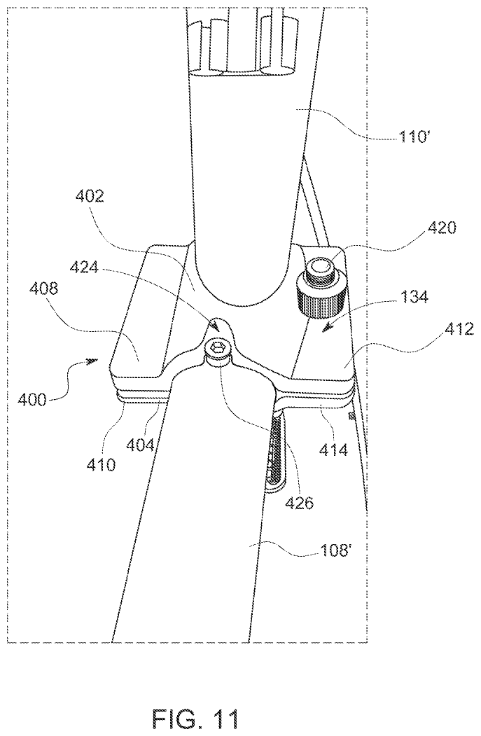

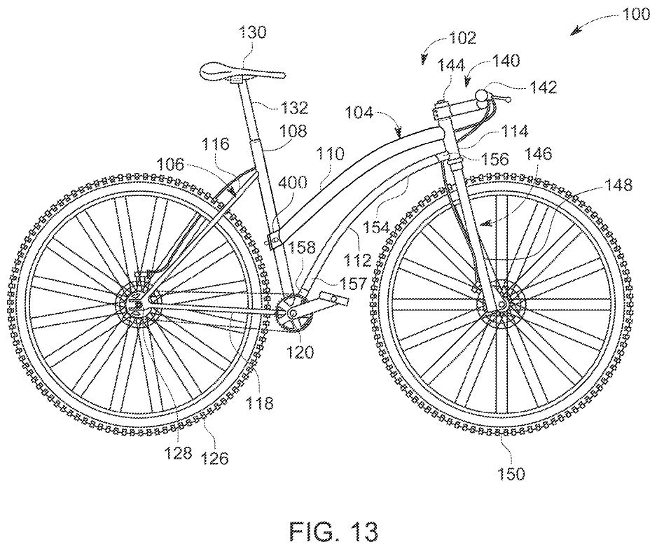

Referring to FIGS. 9-11 and 13, a bicycle frame 102′ according to an alternative embodiment is shown. The bicycle frame 102′ is similar to the bicycle frame 102 except that a seat tube 108′ of the bicycle frame 102′ is a made of a single fixed

itube rather than two tubes as in the bicycle frame 102. Also, a top tube 110′ of the bicycle frame 102′ is pivotally or rotatably connected to the seat tube 108′ at a position below the connection between the seat tube 108′ and the seat stays 116. To enable a rotational engagement of the top tube 110′ with the seat tube 108′, the frame 102′ includes a rotation bracket 400 having a first half portion 402 fixedly engaged with a rear end of the top tube 110′, and a second half portion 404 partially surrounding the seat tube 108′ and engaged with the first half portion 402 and the seat tube 108′. The first half portion 402 and the second half portion 404 together define an elongated channel 406 through which the seat tube 108′ extends. In an embodiment, first lateral ends 408, 410 of the two half portions 402, 404, respectively, are fixedly attached to each other, while second lateral ends 412, 414 of the two half portions 402, 404, respectively, are secured together using a locking fastener 420 having a crank lever 422 that is cammed and adapted to move between a lock position and an unlock position.

In the lock position, the crank lever 422 tightens the locking fastener 420 such that the two half portions 402, 404 are tightly engaged with each other around the seat tube 108′ to prevent the rotation and sliding of the top tube 110′ relative to the seat tube 108′. While in the unlock position of the crank lever 422, the locking fastener 420 is loosened to allow the rotational motion of the top tube 110′ relative to the seat tube 108′ while keeping the top tube 110′ engaged with the seat tube 108′. To move a front frame 104′ of the frame 102′ to the second position relative to the second frame 106′, the down tube is disengaged from the seat tube 108 by disengaging the frame engagement section 160 from the stem 156. Thereafter, the locking fastener 420 is loosened by moving the crank lever 422 to the unlock position.

Subsequently, the front frame 104′ is moved to the second position by rotating the top tube 110′ relative to the seat tube 108′. Furthermore, the rotation bracket 400 defines a cut-out 424 adapted to receive an alignment structure 426 to facilitate a correct position of the top tube 110′ on the seat tube 108′ in the first position of the front frame 104′. In an embodiment, the alignment structure 426 is a protrusion extending radially outwardly from the seat tube 108′. In the first position of the front frame 104′, the alignment structure 426 is arranged, partially, inside the cut-out 424.

It should be appreciated that the collapsible frames 102 and 102′ of the bicycle 100 have substantial benefits for shipping the bicycle 100 in bulk from a manufacturing location to a distribution center and/or retail location. This additionally has benefits directly to a user who can minimize the amount of space required to store their bicycle 100 when not in use. Furthermore, this makes it much easier for a user to transport their own bicycle 100, such as in the trunk of their vehicle. It is well known that bicycles are often transported by automobiles on a bicycle stand or rack, which is located on the exterior of the vehicle, typically on a roof rack, secured to the rear of the vehicle, or secured to a hitch-mounted stand. The collapsible frame 102 disclosed herein makes it much easier for the bicycle 100 to fit into the trunk or rear storage area of many automobiles. Not only is this easier, but it also allows the user to not have to additionally purchase a bicycle stand or rack. Furthermore, stowing the bicycle 100 inside the vehicle also protects the bicycle 100 from the elements and potential damage while traveling outside the vehicle. Lastly, this also provides greater security to the safekeeping of the bicycle 100 while the vehicle and the exteriorly stored bicycle 100 are left unattended.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended specification.

What is claimed is:

1. A bicycle frame comprising:
a front frame having a top tube, a down tube, and a head tube, the top tube being attached to the head tube, and the down tube being positioned below the top tube and further being attached to the head tube;
a rear frame having a pair of spaced-apart seat stays, a pair of spaced-apart chain stays, and a bottom bracket shell, each of the seat stays and the chain stays having a rear end and a front end, the rear ends of the seat stays and the rear ends of the chain stays being connected to a rear drop out, the front end of each chain stay being connected to the bottom bracket shell, and the down tube being releasably connected to the bottom bracket shell;
a seat tube arranged between the front frame and the rear frame and coupled to the front frame and the rear frame, the seat tube having an upper tube and a lower tube, the upper tube and the lower tube being selectively rotatable with respect to one another, the upper tube being connected to the top tube, the lower tube being connected to the front end of the seat stays, and the bottom bracket shell being connected to the lower tube;
wherein the bicycle frame is adapted to be configured in a first position or a second position, in the first position the front frame is positioned forwardly of the seat tube, and in the second position the front frame is rotated rearwardly of the seat tube, wherein the bicycle frame is moved from the first position to the second position by disconnecting the down tube from the bottom bracket shell and rotating the upper tube of the seat tube with respect to the lower tube of the seat tube.

2. The bicycle frame of claim 1 including a locking clip for selectively securing the upper tube of the seat tube to the lower tube of the seat tube to thereby restrict rotation therebetween, the locking clip including a crank lock that is adapted to move between a lock position and an unlock position.

3. The bicycle frame of claim 2 wherein the down tube includes a frame engagement section including a transverse hole, and the bottom bracket shell includes a stem having a pair of spaced-apart flanges, each of the flanges have a though hole which is aligned with one another and oriented axially with the transverse hold of the frame engagement section, wherein the down tube and the bottom bracket shell are connected to one another by inserting the frame engagement section between the flanges so that the transverse hole aligns with both of the through holes, and then inserting a locking pin through the through holes and the transverse hole.

4. The bicycle frame of claim 3 wherein the locking pin is a clevis pin.

5. The bicycle frame of claim 1 wherein the down tube includes a frame engagement section including a transverse hole, and the bottom bracket shell includes a stem having a pair of spaced-apart flanges, each of the flanges have a though hole which is aligned with one another and oriented axially with the transverse hold of the frame engagement section, wherein the down tube and the bottom bracket shell are connected to one another by inserting the frame engagement section between the flanges so that the transverse hole aligns with both of the through holes, and then inserting a locking pin through the through holes and the transverse hole.

6. The bicycle frame of claim 5 wherein the locking pin is a clevis pin.

7. The bicycle frame of claim 1 including a locking coupler for selectively securing the upper tube of the seat tube to the lower tube of the seat tube to thereby restrict rotation therebetween, the locking coupler having a male coupler and a female coupler, the male coupler including a plurality of tongue members, and the female coupler including a plurality of grooves, the tongue members and the grooves being dimensioned so that the tongue members are arranged inside the grooves to prevent rotation between the upper tube and the lower tube.

8. The bicycle frame of claim 7 wherein the down tube includes a frame engagement section including a transverse hole, and the bottom bracket shell includes a stem having a pair of spaced-apart flanges, each of the flanges have a though hole which is aligned with one another and oriented axially with the transverse hold of the frame engagement section, wherein the down tube and the bottom bracket shell are connected to one another by inserting the frame engagement section between the flanges so that the transverse hole aligns with both of the through holes, and then inserting a locking pin through the through holes and the transverse hole.

9. The bicycle frame of claim 8 wherein the locking pin is a clevis pin.

10. A bicycle frame comprising:
a front frame having a top tube, a down tube, and a head tube, the top tube being attached to the head tube, and the down tube being positioned below the top tube and further being attached to the head tube;
a rear frame having a pair of spaced-apart seat stays, a pair of spaced-apart chain stays, a seat tube, and a bottom bracket shell, each of the seat stays and the chain stays having a rear end and a front end, the rear ends of the seat stays and the rear ends of the chain stays being connected to a rear drop out, the front end of each chain stay being connected to the bottom bracket shell, the front end of each seat stay being connected to the seat tube;
the down tube being releasably connected to the bottom bracket shell, and the top tube being rotatably connected to the seat tube;
wherein the bicycle frame is adapted to be configured in a first position or a second position, in the first position the front frame is positioned forwardly of the seat tube, and in the second position the front frame is rotated rearwardly of the seat tube, wherein the bicycle frame is moved from the first position to the second position by disconnecting the down tube from the bottom bracket shell and rotating the top tube about the seat tube.

11. The bicycle frame of claim 10 including a rotation bracket having a first half portion and a second half portion, the first half portion being fixedly engaged with a rear end of the top tube, and the second half portion partially surrounding the seat tube and engaged with the first half portion and the seat tube, the first half portion and the second half portion define an elongated channel through which the seat tube extends, the first half portion and the second half portion are fixedly attached together at a first lateral end, and the first half portion and the second half portion are secured together at a second lateral end.

12. The bicycle frame of claim 11 wherein the first half portion and the second half portion are secured together using a locking fastener having a crank lever that is adapted to move between a lock position and an unlock position in which the crank lever tightens the locking fastener such that the first half portion and the second half portion are tightly engaged with each other around the seat tube to prevent the top tube from sliding or rotating relative to the seat tube.

13. The bicycle frame of claim 12 wherein the down tube includes a frame engagement section including a transverse hole, and the bottom bracket shell includes a stem having a pair of spaced-apart flanges, each of the flanges have a though hole which is aligned with one another and oriented axially with the transverse hold of the frame engagement section, wherein the down tube and the bottom bracket shell are connected to one another by inserting the frame engagement section between the flanges so that the transverse hole aligns with both of the through holes, and then inserting a locking pin through the through holes and the transverse hole.

14. The bicycle frame of claim 13 wherein the locking pin is a clevis pin.

15. The bicycle frame of claim 10 wherein the down tube includes a frame engagement section including a transverse hole, and the bottom bracket shell includes a stem having a pair of spaced-apart flanges, each of the flanges have a though hole which is aligned with one another and oriented axially with the transverse hold of the frame engagement section, wherein the down tube and the bottom bracket shell are connected to one another by inserting the frame engagement section between the flanges so that the transverse hole aligns with both of the through holes, and then inserting a locking pin through the through holes and the transverse hole.

16. The bicycle frame of claim 15 wherein the locking pin is a clevis pin.
